(19) United States
(12) Patent Application Publication
(10) Pub. No.: US 2024/0137543 A1
(43) Pub. Date: Apr. 25, 2024

(54) SYSTEMS AND METHODS FOR DECODER-SIDE SYNTHESIS OF VIDEO SEQUENCES

(71) Applicant: OP Solutions, LLC, Amherst, MA (US)

(72) Inventors: Hari Kalva, BOCA RATON, FL (US); Borivoje Furht, BOCA RATON, FL (US); Velibor Adzic, Canton, GA (US)

(73) Assignee: OP Solutions, LLC, Amherst, MA (US)

(21) Appl. No.: 18/400,345

(22) Filed: Dec. 29, 2023

Related U.S. Application Data
(63) Continuation of application No. PCT/US22/36089, filed on Jul. 5, 2022.
(60) Provisional application No. 63/220,326, filed on Jul. 9, 2021.

(51) Int. Cl. H04N 19/44; H04N 19/12; H04N 19/137; H04N 19/172; H04N 19/463; H04N 19/60

(52) U.S. Cl. CPC H04N 19/44; H04N 19/12; H04N 19/137; H04N 19/172; H04N 19/463; H04N 19/60

(57) ABSTRACT

A method of decoder-side synthesis of video sequences includes receiving, by an encoder, an input video, detecting, by the encoder and in the input video, a first region including synthesizable content, and encoding, by the encoder and in a bitstream, the video, wherein encoding further comprises signaling the first region.

### CROSS REFERENCE TO RELATED APPLICATIONS

This application is a continuation of international application PCT/US22/36089 filed on Jul. 5, 2022, and entitled SYSTEMS AND METHODS FOR DECODER-SIDE SYNTHESIS OF VIDEO SEQUENCES, which application claims the benefit of priority to U.S. Provisional Application, Ser. No. 63/220,326, filed on Jul. 9, 2021, and entitled SYSTEMS AND METHODS FOR DECODER-SIDE SYNTHESIS OF VIDEO SEQUENCES, which is incorporated by reference in its entirety.

### FIELD OF THE INVENTION

The present invention generally relates to the field of video encoding and decoding. In particular, the present invention is directed to systems and methods for decoder-side synthesis of video sequences.

### BACKGROUND

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, ease of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

### SUMMARY OF THE DISCLOSURE

A method of encoding video for decoder-side synthesis of video sequences is provided. The method includes receiving an input video, detecting at least a first region in the video including synthesizable content, and encoding the video, wherein encoding further comprises signaling the first region in the bitstream. The first region can be any increment of a video and may include a frame, or a sub-frame. The signaling may comprise signaling a transformation of the first region, which may include transformations such as an affine transformation or a translation. The signaling may include signaling a model identifier identifying a motion model describing the synthesizable content. The motion model may be fluid model.

The encoding method may include detecting a second region in the video that does not including synthesizable content and encoding the second region. Optionally, the encoding method may include skipping encoding of the first region. In certain embodiments, the encoding method may further comprise signaling, in the bitstream, at least a reference image for the first region.

A method of decoder-side synthesis of video sequences includes receiving a coded bitstream which includes at least a parameter signaling a first region of the video including synthesizable content. Decoding the video further comprises determining a synthesizable content model for the first region using the at least a parameter and generating the content of the first region using the synthesizable content model.

The first region may include any portion of video, such as a frame or sub-frame. In some embodiments the method includes receiving a transformation of the first region, such as one of affine transformation or translation. The parameter in the bitstream may be a signal indicating at least a model parameter.

In some cases, the bitstream encodes a second region not including synthesizable content and the decoding of the video further comprises decoding the second region. The method may, in some embodiments, include skipping decoding of the first region. In some embodiments, the bitstream may include a reference image for the first region and the method includes detecting the reference image.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic diagram illustrating an exemplary embodiment of a frame with a region of synthesizable content;

FIG. 2 is a block diagram illustrating an exemplary embodiment of a machine-learning module;

FIG. 3 is a block diagram illustrating an exemplary embodiment of a neural network;

FIG. 4 is a block diagram illustrating an exemplary embodiment of a neural network node;

FIG. 5 is a flow diagram illustrating an exemplary embodiment of a method of decoder-side synthesis of video sequences;

FIG. 6 is a block diagram illustrating an exemplary embodiment of a video decoder;

FIG. 7 is a flow diagram illustrating an exemplary embodiment of a method of decoder-side synthesis of video sequences;

FIG. 8 is a block diagram illustrating an exemplary embodiment of a video encoder; and

FIG. 9 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Video compression technologies may exploit similarities among successive frames of a sequence to compress the sequence. As similarity among successive frames of a sequence decreases, compressibility of frames decreases. This means that for the same quality of video, for instance for the same level of quantization, as compressibility decreases, a size of a bitstream output by an encoder may increase, or in other words a bitrate of the bitstream may increase. In video sequences with low compressibility, successive frames may have low similarity. A class of video sequences with low compressibility may include videos with fluid flows, such as without limitation videos depicting waterfalls, waves in an ocean, smoke, fire, fireworks, rain, and/or explosions. A key characteristic of such sequences may include that an exact detail of a fluid flow may not be essential to understanding a video sequence and/or semantics thereof. For example, an estimation of water flow may function as an acceptable substitution of the original flow, with differences slight enough that users are unlikely to notice any difference. Film grain introduced for artistic effects may function as another example.

Embodiments disclosed herein may use neural networks and/or deep learning methods to estimate or generate an animated flow of fluids based on a single static image and/or two or more reference static images. For example, a static image of a waterfall may be used to generate subsequent frames of a waterfall with estimated water and/or fluid flow. This technology may be effectively used to improve video compression where portions of a video sequence are not compressed at the sender/encoder but generated at the receiver and/or decoder side and presented to the user. This approach may improve compression by skipping compression and/or encoding of certain frames and/or portions thereof, such as without limitation subframes, subpictures, blocks, tiles, slices, coding units, coding tree units, or the like, and signaling to a receiver and/or decoder that the skipped regions may be generated using a method such as a deep neural network and/or other neural network.

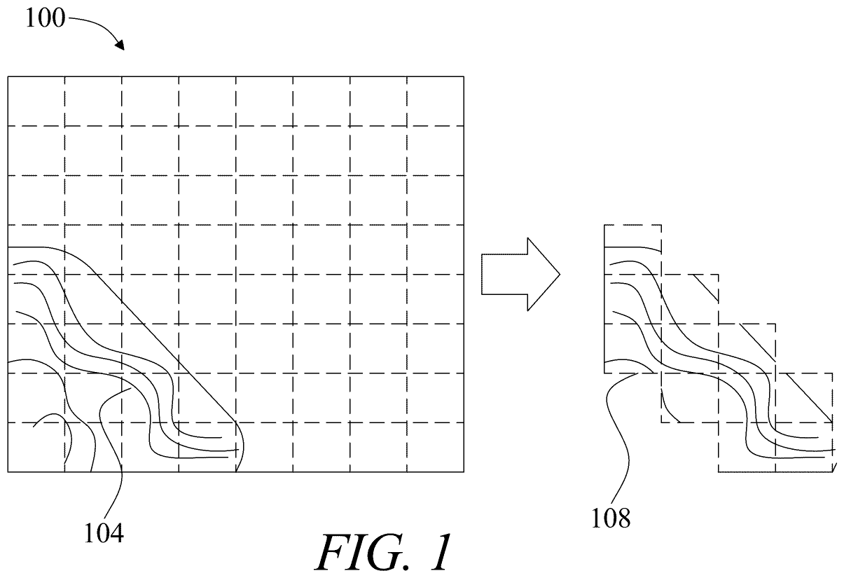

When encoding a video sequence, an encoder may determine whether a frame (or a portion of a frame) is suitable for receiver side generation. For instance, and referring to FIG. 1, a video frame 100 and/or sequence thereof may have at least a portion 104 in which synthesizable content as described above is presented and/or detected, for instance by an encoder. As used herein, “synthesizable content” is content, such as for example fluid motion, that may be synthesized and/or generated using models as described in this disclosure; synthesizable content may include any content for which model-produced and/or synthesized output is not perceptibly different from captured content to a typical viewer. In a non-limiting example, at least a portion 104 may be identified by a user. In another non-limiting example, at least a portion 104 may be identified using trained neural network, deep learning network, and/or machine-learning model. As a non-limiting example, a classifier such as a neural network classifier, deep learning classifier, or the like may be trained using training examples correlating subframes, frame sequences, and/or subframe sequences depicting synthesizable content with, e.g., user identifications of synthesizable content and/or user identifications of particular models that may be used to model synthesizable content of one category or another.

Still referring to FIG. 1, portion 104 may be extracted and/or signaled as a separate subframe 108, sequence of subframes, frame, sequence of subframes, and/or sequence of frames. An encoder may skip encoding such frame, subframe, sequence of frames, and/or sequence of subframes and instead include a signal in the bitstream to indicate that the corresponding region may be generated at a decoder and/or receiver. Such signaling may occur at a frame level, a block level, or at another subframe level. Example syntax for signaling a portion of a block or picture header signaling a synthesized skip may be provided as described in the following table:

| | Descriptor |
|---|---|
| .. | |
| .. | |
| .. | |
| synthesized_skip | u(1) |
| if(synthesized_skip) { | |
| synthesize_skip_info( ) | |
| } | |
| synthesize_skip_info( ) { | |
| nn_model_id | u(6) |
| nn_model_params_present | u(1) |
| if(nn_model_params_present) { | |
| param_count_minus1 | u(8) |
| for( i = 0; i <= param_count_minus1; i++ ) { | |
| model_param[ i ] | u(64) |
| } | |
| } | |
| src_frm_idx_present | u(1) |
| if(src_frm_idx_present) { | |
| src_frm_count_minus1 | u(3) |
| for( i = 0; i <= src_frm_count_minus1; i++ ) { | |
| frame_reference_id[ i ] | u(6) |
| } | |
| } | |
| frames_to_generate | u(6) |
| quality_factor | u(6) |
| } | |

Still referring to FIG. 1, semantics in the above-described example may include, as non-limiting examples of parameters, synthesized_skip; in an embodiment when a value thereof is 1, a corresponding region may not be explicitly compressed in a bitstream. This may signal to a receiver and/or decoder that a corresponding region may be generated and/or composed in a decoded picture. A parameter denoted as nn_model_id may signal an identifier of a model, such as a neural net model, deep learning model, or the like to be used for generating the next set of frames. A model may be selected based on the content to be generated. A trained model for waterfall may for instance and without limitation be different from a trained model for generating smoke. Each such model may be trained using training examples correlating categories of synthesizable content to sequences of frames and/or subframes. A decoder and/or receiver may retrieve models using model identifiers and/or queries containing model identifiers as signaled in the bitstream. Such models may be stored in a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

A parameter denoted nn_model_params_present may signal a presence of additional model parameters specific to a selected model. Interpretation of such model parameter and/or parameters may be specific to each model. Signaled parameters may include, without limitation, coefficients, weights, and/or biases of neural networks and/or other machine-learning models, which a decoder and/or receiver may use to generate such models without having stored such models locally. A parameter which may be denoted param_count_minus1 may indicate a number of model parameters encoded for a given model. One or more fields indicated by and/or passed as vector indices of a parameter which may be denoted model_param may contain one or more model parameter values for a given model.

A parameter which may be denoted as src_frm_idx_present may signal one or more source frames to be used to generate the synthesized frames. A value of 0 may signal that a fully decoded frame temporally closest to the current frame is used as a source. A value of 1 may signal that a frame index of source frames will be explicitly signaled; index may include an index in a buffer, array, or other data structure containing potential source frames, reference frames, decoded frames, or the like. When signaling for blocks, a collocated block in a source frame may be used as input to the NN mode. A parameter which may be denoted src_frm_count_minus1 may signal a number of frames used as input to an NN model generating a frame, set of frames, region, subframe, and/or set of subframes. A parameter which may be denoted as frame_reference_id may signal an index of a previously decoded frame to be used as a source. A parameter that may be denoted frames_to_generate_minus1 may signal a number of frames a decoder model is to generate. This also may imply that synthesize skip info may be skipped for a subsequent “frames_to_generate_minus1” number of frames. A parameter that may be denoted as quality_factor may indicate a quality level to be used to blend generated regions into the rest of a frame. For example, a generated video may have to be quantized to reduce quality to match the rest of a coded frame. Note that identifiers of sub-regions of frames, such as slice identifiers, identifiers of blocks, coding units, coding tree units, or the like may be used to identify sub-regions to be modeled and/or sub-regions to be encoded and/or decoded using video compression. The above-described semantics are provided for exemplary purposes only. Persons skilled in the art, upon reviewing the entirety of this disclosure, will be aware that alternative parameter and/or variable names may be used, and/or that signaling these parameters may include signaling other parameters from which these parameters may be derived; all such variations are contemplated as being within the scope of this disclosure.

Still referring to FIG. 1, encoder may signal transformation within a video picture of a subregion within a frame, such as a subregion containing synthesizable content to be modeled, using one or more translational and/or affine motion models. As an example, simple translational motion may be described using a motion vector (MV) with two components MVx, MVy that describe displacement of blocks and/or pixels in a current frame. More complex motion such as rotation, zooming, and warping may be described using affine motion vector, where an “affine motion vector,” as used in this disclosure, is a vector describing a uniform displacement of a set of pixels or points represented in a video picture and/or picture, such as a set of pixels illustrating an object moving across a view in a video without changing apparent shape during motion. Some approaches to video encoding and/or decoding may use 4-parameter or 6-parameter affine models for motion compensation in inter picture coding.

For example, a six parameter affine motion can be described as:

x′=ax+by+c

y′=dx+ey+f

And a four parameter affine motion can be
described as:

x′=ax+by+c

y′=−bx+ay+f

where (x,y) and (x′,y′) are pixel locations in current and reference pictures, respectively; a, b, c, d, e, and f are the parameters of the affine motion model.

Parameters used describe affine motion may be signaled to a decoder to apply affine motion compensation at the decoder. In some approaches, motion parameters may be signaled explicitly or by signaling translational control point motion vectors (CPMVs) and then deriving affine motion parameters from the translational control point motion vectors. Two control point motion vectors may be utilized to derive affine motion parameters for a four-parameter affine motion model and three control point translational motion vectors may be utilized to obtain parameters for a six-parameter motion model. Signaling affine motion parameters using control point motion vectors may allow use of efficient motion vector coding methods to signal affine motion parameters.

Video encoders using predictive coding may rely on previously decoded data to form predictions. When portions of a frame are synthesized at a decoder, corresponding regions may not be available to encoders. For example, floating point arithmetic and/or rounding may produce differences in synthesized images generated on different machines. To overcome this reference data mismatch, a region signaled as synthesized_skip, or in other words as a region to be generated at a decoder, may be marked as unavailable for reference purposes and future frames may not use that unavailable region for prediction.

Still referring to FIG. 1, many video games may contain content with complex fluid flows such as explosions and smoke. Such content may be difficult to compress and may increase a bitrate of video streamed to a player device in a cloud gaming use case. Quality of such gaming may be improved by synthesizing certain regions of a rendered and streamed video game using embodiments of systems and/or methods as described in this disclosure. In this solution, a game video encoder in the cloud may generate video and signal regions to be synthesized at a receiver. A user device may decode video and synthesize regions as signaled. Decoder side synthesis may be done on a graphics processing unit and/or a hardware accelerated neural network inference engine, as non-limiting examples.

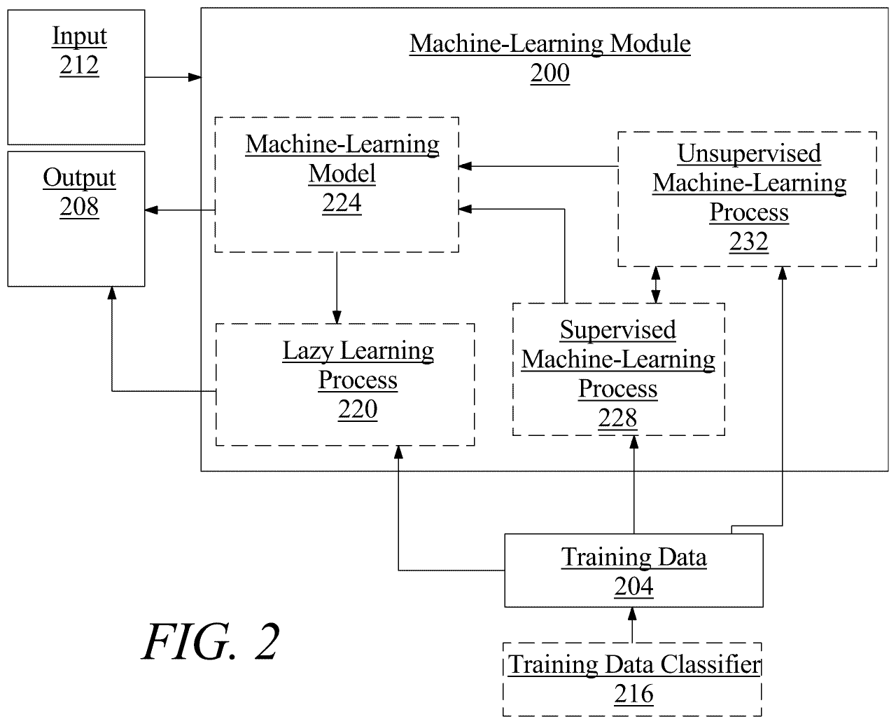

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

Further referring to FIG. 2, training data may be filtered, sorted, and/or selected using one or more supervised and/or unsupervised machine-learning processes and/or models as described in further detail below; such models may include without limitation a training data classifier 216.

Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a process whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs as described in this disclosure as inputs, outputs as described in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure.

Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

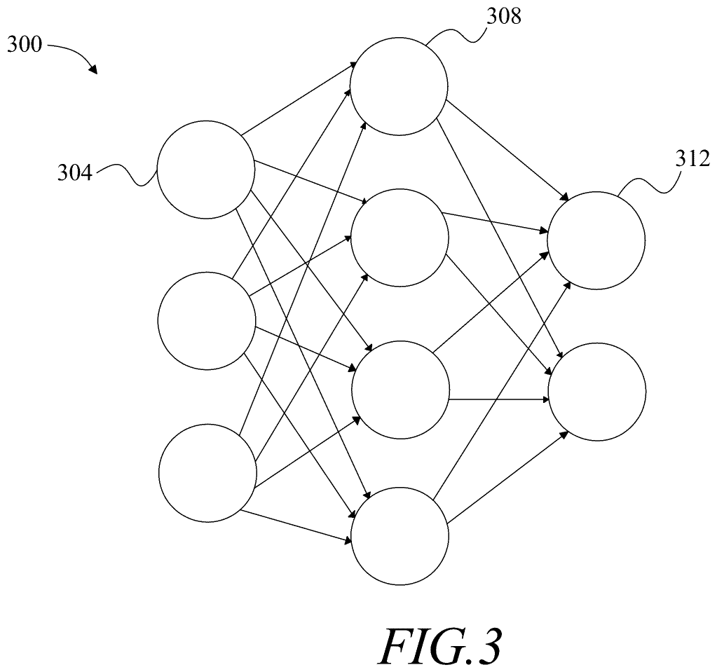

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.”

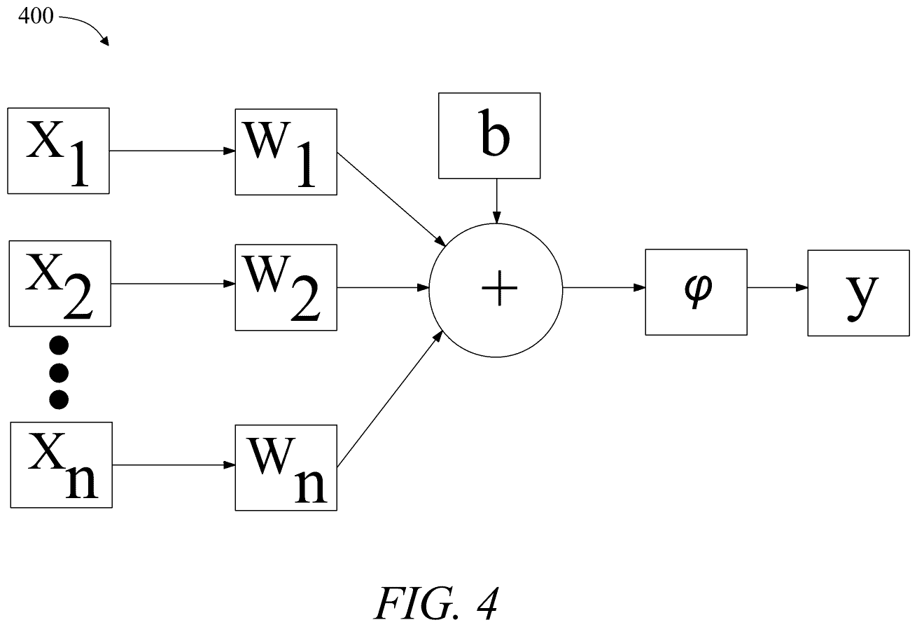

Referring now to FIG. 4, an exemplary embodiment of a node of a neural network is illustrated. A node may include, without limitation a plurality of inputs xi that may receive numerical values from inputs to a neural network containing the node and/or from other nodes. Node may perform a weighted sum of inputs using weights wi that are multiplied by respective inputs xi. Additionally or alternatively, a bias b may be added to the weighted sum of the inputs such that an offset is added to each unit in the neural network layer that is independent of the input to the layer. The weighted sum may then be input into a function gyp, which may generate one or more outputs y. Weight wi applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above.

Still referring to FIG. 4, a “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A computing device such as an encoder, decoder, and/or receiver may generate a classifier using a classification algorithm, defined as a process whereby a computing device derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 4, a computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. A computing device may then calculate a likelihood table by calculating probabilities of different data entries and classification labels. Computing device 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 4, a decoder and/or encoder may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 4, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute 1 as derived using a Pythagorean norm: 1=\sqrt{Σᵢⁿαᵢ²} where ai is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

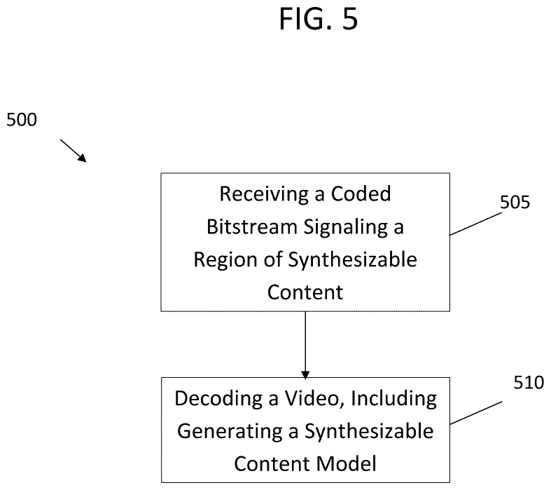

Referring now to FIG. 5, an exemplary embodiment of a method of decoder-side synthesis of video sequences is illustrated. At step 505, a decoder receives a coded bitstream encoding a video, wherein the bitstream includes at least a parameter signaling a first region including synthesizable content, such as a region of fluid motion. This may be implemented without limitation as described above. First region may include at least a frame. First region may include at least a sub-frame. Receiving may include receiving a transformation of first region. Transformation may include an affine transformation. Transformation may include a translation. Receiving may include detecting a signal indicating a model identifier identifying a motion model describing synthesizable content. Receiving may include detecting a signal indicating a presence of model parameters. Receiving may include detecting a signal indicating a number of model parameters. Receiving may include detecting at least a signal indicating at least a model parameter.

Still referring to FIG. 5, at step 510, decoder decodes video, wherein decoding the video includes generating a synthesizable content model using at least a parameter from the bitstream and animating a first region using the synthesizable content model; this may be implemented without limitation as described above. Synthesizable content model may include, without limitation, any neural network, deep learning network, and/or other machine-learning mode. In some embodiments, decoder may generate synthesizable content model by training synthesizable content model using training examples correlating frame sequences of real-life synthesizable content to static images thereof. In one exemplary case, the synthesizable content is characterized by fluid motion.

Alternatively, decoder may receive parameters of a synthesizable content model in the bitstream, retrieve such parameters from memory, and/or receive from a remote device, and instantiate a model using parameters. In either case, decoder may feed reference frame and/or frames, reference sub-regions, or the like, which may be signaled using any sub-region signaling described above, along with numbers of frames and/or regions thereof to be modeled, to the model; frames and/or regions synthesized by the model may be output and combined with frame sequences and/or groups of pictures as described above.

In an embodiment, and with continued reference to FIG. 5, bitstream may encode a second region not including synthesizable content. Decoding video may include decoding second region. Decoding video may include skipping encoding of first region. In some embodiments, decoder may detect, in a bitstream, at least a reference image for the first region, where at least a reference image includes at least one still image of the fluid to be animated; reference image may include a whole frame or a region of a frame as described above.

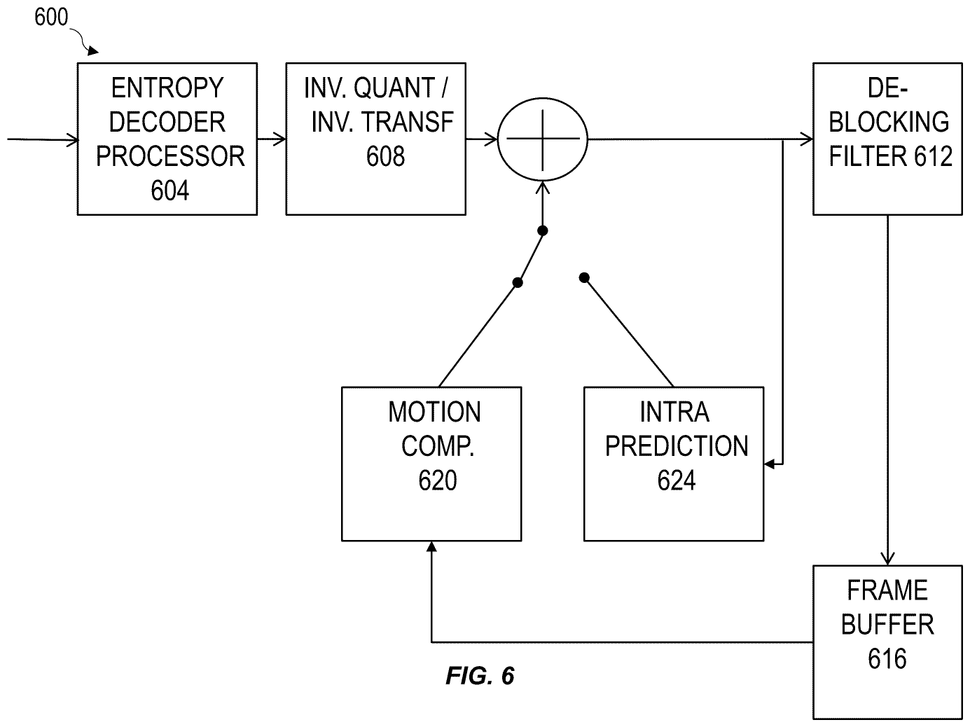

FIG. 6 is a system block diagram illustrating an example decoder 600. Decoder 600 may include an entropy decoder processor 604, an inverse quantization and inverse transformation processor 608, a deblocking filter 612, a frame buffer 616, a motion compensation processor 620 and/or an intra prediction processor 624.

In operation, and still referring to FIG. 6, bit stream 628 may be received by decoder 600 and input to entropy decoder processor 604, which may entropy decode portions of bit stream into quantized coefficients. Quantized coefficients may be provided to inverse quantization and inverse transformation processor 608, which may perform inverse quantization and inverse transformation to create a residual signal, which may be added to an output of motion compensation processor 620 or intra prediction processor 624 according to a processing mode. An output of the motion compensation processor 620 and intra prediction processor 624 may include a block prediction based on a previously decoded block. A sum of prediction and residual may be processed by deblocking filter 612 and stored in a frame buffer 616.

In an embodiment, and still referring to FIG. 6 decoder 600 may include circuitry configured to implement any operations as described above in any embodiment as described above, in any order and with any degree of repetition. For instance, decoder 600 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

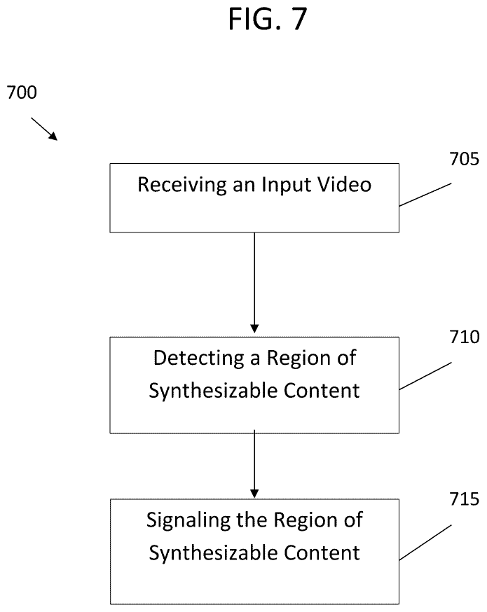

Referring now to FIG. 7, an exemplary embodiment of a method 700 of decoder-side synthesis of video sequences is illustrated. At step 705, an encoder may receive an input video; this may be implemented without limitation as described above.

At step 710, and still referring to FIG. 7, encoder detects, in input video, a first region including synthesizable content. The synthesizable content may be a region of fluid motion. This may be implemented without limitation as described above. First region may include at least a frame. First region may include at least a sub-frame.

At step 715, and with continued reference to FIG. 7, encoder encodes video in a bitstream, wherein encoding further comprises signaling at least a first region having synthesizable content. This may be implemented without limitation as described above. Signaling may include signaling a transformation of first region. Transformation may include an affine transformation. Transformation may include a translation. Signaling may include signaling a model identifier identifying a motion model describing synthesizable content. Signaling may include signaling a presence of model parameters. Signaling may include signaling a number of model parameters. Signaling may include signaling at least a model parameter. Encoder may detect a second region not including synthesizable content; encoding video may include encoding the second region. Encoding video may include skipping encoding of first region. Encoder may signal, in the bitstream, at least a reference image for first region.

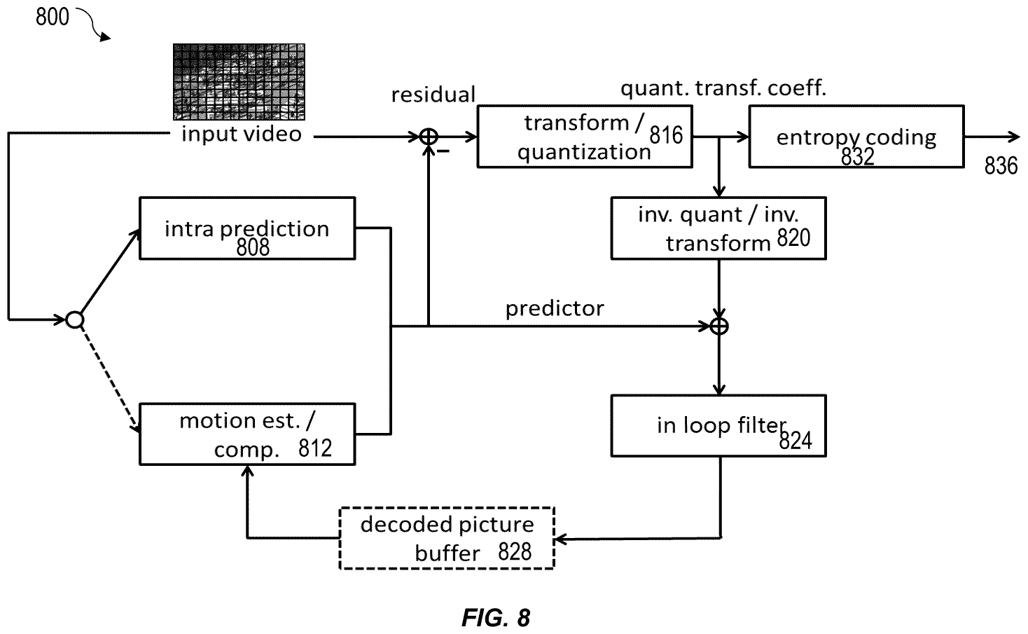

FIG. 8 is a system block diagram illustrating an example video encoder 800.

Example video encoder 800 may receive an input video 804, which may be initially segmented or dividing according to a processing scheme, such as a tree-structured macro block partitioning scheme (e.g., quad-tree plus binary tree). An example of a tree-structured macro block partitioning scheme may include partitioning a picture frame into large block elements called coding tree units (CTU). In some implementations, each CTU may be further partitioned one or more times into a number of sub-blocks called coding units (CU). A final result of this portioning may include a group of sub-blocks that may be called predictive units (PU). Transform units (TU) may also be utilized.

Still referring to FIG. 8, example video encoder 800 may include an intra prediction processor 808, a motion estimation/compensation processor 812, which may also be referred to as an inter prediction processor, capable of constructing a motion vector candidate list including adding a global motion vector candidate to the motion vector candidate list, a transform/quantization processor 816, an inverse quantization/inverse transform processor 820, an in-loop filter 824, a decoded picture buffer 828, and/or an entropy coding processor 832. Bit stream parameters may be input to the entropy coding processor 832 for inclusion in the output bit stream 836. In operation, and with continued reference to FIG. 8, for each block of a frame of input video, whether to process block via intra picture prediction or using motion estimation/compensation may be determined. Block may be provided to intra prediction processor 808 or motion estimation/compensation processor 812. If block is to be processed via intra prediction, intra prediction processor 808 may perform processing to output a predictor. If block is to be processed via motion estimation/compensation, motion estimation/compensation processor 812 may perform processing including constructing a motion vector candidate list including adding a global motion vector candidate to the motion vector candidate list, if applicable.

Further referring to FIG. 8, a residual may be formed by subtracting a predictor from input video. Residual may be received by transform/quantization processor 816, which may perform transformation processing (e.g., discrete cosine transform (DCT)) to produce coefficients, which may be quantized. Quantized coefficients and any associated signaling information may be provided to entropy coding processor 832 for entropy encoding and inclusion in output bit stream 836. Entropy encoding processor 832 may support encoding of signaling information related to encoding a current block. In addition, quantized coefficients may be provided to inverse quantization/inverse transformation processor 820, which may reproduce pixels, which may be combined with a predictor and processed by in loop filter 824, an output of which may be stored in decoded picture buffer 828 for use by motion estimation/compensation processor 812 that is capable of constructing a motion vector candidate list including adding a global motion vector candidate to the motion vector candidate list.

With continued reference to FIG. 8, although a few variations have been described in detail above, other modifications or additions are possible. For example, in some implementations, current blocks may include any symmetric blocks (8x8, 16x16, 32x32, 64x64, 128x128, and the like) as well as any asymmetric block (8x4, 16x8, and the like).

In some implementations, and still referring to FIG. 8, a quadtree plus binary decision tree (QTBT) may be implemented. In QTBT, at a Coding Tree Unit level, partition parameters of QTBT may be dynamically derived to adapt to local characteristics without transmitting any overhead. Subsequently, at a Coding Unit level, a joint-classifier decision tree structure may eliminate unnecessary iterations and control the risk of false prediction. In some implementations, LTR frame block update mode may be available as an additional option available at every leaf node of QTBT.

In some implementations, and still referring to FIG. 8, additional syntax elements may be signaled at different hierarchy levels of bitstream. For example, a flag may be enabled for an entire sequence by including an enable flag coded in a Sequence Parameter Set (SPS). Further, a CTU flag may be coded at a coding tree unit (CTU) level.

Some embodiments may include non-transitory computer program products (i.e., physically embodied computer program products) that store instructions, which when executed by one or more data processors of one or more computing systems, cause at least one data processor to perform operations herein.

Still referring to FIG. 8, encoder 800 may include circuitry configured to implement any operations as described above in any embodiment, in any order and with any degree of repetition. For instance, encoder 800 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 800 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 8, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder 900 and/or encoder 800 may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

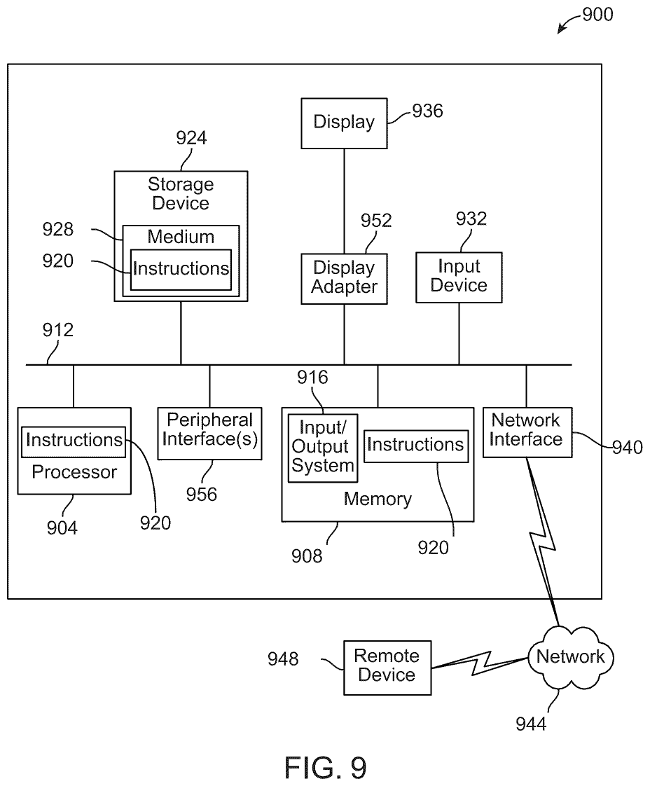

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Processor 904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 904 may be organized according to Von Neumann and/or Harvard architecture as a non-limiting example. Processor 904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of encoding video for decoder-side synthesis of video sequences, the method comprising:
receiving an input video;
detecting a first region in the video including synthesizable content; and
encoding the video, wherein encoding further comprises signaling the first region in the bitstream.

2. The method of claim 1, wherein the first region includes at least a frame.

3. The method of claim 1, wherein the first region includes at least a sub-frame.

4. The method of claim 1, wherein signaling further comprises signaling a transformation of the first region.

5. The method of claim 4, wherein the transformation further comprises one of an affine transformation and a translation.

6. The method of claim 1, wherein signaling further comprises signaling a model identifier identifying a motion model describing the synthesizable content.

7. The method of claim 1, wherein signaling further comprises signaling a presence of model parameters.

8. The method of claim 1, wherein signaling further comprises signaling at least a model parameter.

9. The method of claim 1 further comprising detecting a second region not including synthesizable content.

10. The method of claim 9, wherein encoding the video further comprises encoding the second region.

11. The method of claim 10, wherein encoding the video further comprises skipping encoding of the first region.

12. The method of claim 1 further comprising signaling, in the bitstream, at least a reference image for the first region.

13. A method of decoder-side synthesis of video sequences, the method comprising:
receiving a coded bitstream, wherein the bitstream includes at least a parameter signaling a first region including synthesizable content; and
decoding the video, wherein decoding the video further comprises:
determining a synthesizable content model for the first region using the at least a parameter; and
generating the content of the first region using the synthesizable content model.

14. The method of claim 13, wherein the first region includes at least a frame.

15. The method of claim 13, wherein the first region includes at least a sub-frame.

16. The method of claim 13, wherein receiving further comprises receiving a transformation of the first region, the transformation being selected from one of affine transformation and translation.

17. The method of claim 13, wherein receiving further comprises detecting at least a signal indicating at least a model parameter.

18. The method of claim 13, wherein the bitstream encodes a second region not including synthesizable content and wherein decoding the video further comprises decoding the second region.

19. The method of claim 18, wherein decoding the video further comprises skipping encoding of the first region.

20. The method of claim 19 further comprising detecting, in the bitstream, at least a reference image for the first region.
